(19) United States
(12) Patent Application Publication
(10) Pub. No.: US 2013/0285819 A1
(43) Pub. Date: Oct. 31, 2013

(54) Inspection method of backlight module and inspection apparatus thereof

(71) Applicants: Hao Huang, Shenzhen (CN); Chun Liu, Shenzhen (CN); Chang-hung Pan, Shenzhen (CN)

(72) Inventors: Hao Huang, Shenzhen (CN); Chun Liu, Shenzhen (CN); Chang-hung Pan, Shenzhen (CN)

(73) Assignee: SHENZHEN CHINA STAR OPTOELECTRONICS TECHNOLOGY CO, LTD., Guangdong (CN)

(21) Appl. No.: 13/518,756

(22) PCT Filed: May 4, 2012
(86) PCT No.: PCT/CN12/75064

§ 371 Date: Jun. 22, 2012

(30) Foreign Application Priority Data
Apr. 27, 2012 (CN) 201210129108.1

(51) Int. Cl. G01J 1/10; G08B 21/00

(52) U.S. Cl. 340/600; 250/214.1; 250/208.2

(57) ABSTRACT

The present invention provides an inspection method of a backlight module and an inspection apparatus. The inspection method of the backlight module comprising: obtaining space brightness values of multiple positions of the backlight module on an inspection machine when the backlight module is setting in standard luminance mode, and setting the space brightness values as standard brightness values; obtaining real-time space brightness values of the multiple positions of the backlight module; comparing the real-time space brightness values with the standard space brightness values in order to determine if the backlight module is abnormal. The present invention compares the real-time space brightness values measured by the brightness meters with the standard space brightness values corresponding to the standard luminance mode of the backlight module in order to determine if the backlight module is abnormal instantaneously, and using the brightness meters to replace the luminance meters results in cost saving.

### BACKGROUND OF THE INVENTION

1. Field of the Invention

The present invention relates to optical measuring technology, more particularly, to an inspection method of a backlight module and an inspection apparatus of the backlight module.

2. Description of Related Art

Backlight module is one of the key components of the liquid crystal display (LCD). Because liquid crystal cannot emit light themselves, a light source must be disposed under a LCD panel to display color. The function of the backlight module is providing a sufficient brightness and uniform planar light source such that the LCD can display image. Therefore, in the development process of the LCD, the backlight module has absolute influence for improving the LCD display performance, and luminance of the backlight module is an important factor to judge the performance of the backlight module.

In the prior art, it generally uses a luminance meter (BM-7 type luminance brightness meter) and a TFT-LCD panel lighting test machine (Table automatic measurement machine) to inspect the luminance of the backlight module. The operation processes are: inspectors handheld the luminance meter and stand in front of the TFT-LCD panel lighting test machine; regularly inspect some positions of the backlight module, record the dates of the luminance meter, and compare the above dates with standard luminance data; determine if the backlight module is abnormal. The above inspection method can not achieve real-time monitoring of the backlight module, and easily lead to errors caused by human factors.

In summary, it is necessary to provide an inspection method of a backlight module and an inspection apparatus to solve the above problems.

### SUMMARY OF THE INVENTION

The main technical problem solved by the present invention is providing an inspection method of a backlight module and an inspection apparatus thereof to solve the problem of inspecting the backlight module instantaneously, unachievable in the prior art.

In order to solve the above technical problems, the technical solution used in this invention are: providing an inspection method of a backlight module comprising: obtaining space brightness values of multiple positions of the backlight module on the inspection machine when the backlight module is setting in standard luminance mode, and setting the space brightness values as standard brightness values; obtaining real-time space brightness values of the multiple positions of the backlight module; setting a predetermined threshold brightness value and comparing the real-time space brightness values with the standard space brightness values, wherein if the difference between the two is less than or equal to the predetermined threshold value, determining the backlight module is normal, and if the difference between the two is greater than the predetermined threshold value, determining the backlight module is abnormal and generating an alarm signal.

Wherein, the multiple positions are located at four sides of the backlight module.

In order to solve the above technical problems, another technical solution used in this invention is: providing a backlight module inspection method comprising the following steps: obtaining space brightness values of multiple positions of the backlight module on an inspection machine when the backlight module is setting in standard luminance mode, and setting the space brightness values as standard brightness values; obtaining real-time space brightness values of the multiple positions of the backlight module; comparing the real-time space brightness values with the standard space brightness values in order to determine if the backlight module is abnormal.

Wherein, the multiple positions are located at four sides of the backlight module.

Wherein, in the step of comparing the real-time space brightness values with the standard space brightness values in order to determine if the backlight module is abnormal comprises: comparing the real-time space brightness values with the standard space brightness values, wherein if the difference between the two is greater than a predetermined threshold value, determining the backlight module is abnormal, and if the difference between the two is less than or equal to the predetermined threshold value, determining the backlight module is normal.

Wherein, before the step of comparing the real-time space brightness values with the standard space brightness values in order to determine if the backlight module is abnormal comprises: setting the predetermined threshold brightness value.

Wherein, the inspection method further comprising: generating an alarm signal if the backlight module is abnormal.

To solve the above technical problems, another technical solution used in this invention is: providing an inspection apparatus comprising: an inspection machine for carrying a backlight module; multiple brightness meters located at multiple positions for measuring space brightness values of multiple positions of the backlight module when the backlight module is setting in standard luminance mode and real-time space brightness values of the multiple positions of the backlight module; a controller for setting the space brightness values as standard brightness values and comparing the real-time space brightness values with the standard space brightness values in order to determine if the backlight module is abnormal.

Wherein, the multiple positions are located at four sides of the backlight module.

Wherein, the controller compares the real-time space brightness values with the standard space brightness values, and if the difference between the two is greater than a predetermined threshold value, determining the backlight module is abnormal, and if the difference between the two is less than or equal to the predetermined threshold value, determining the backlight module is normal.

Wherein, the inspection apparatus further comprises an input device for inputting the predetermined threshold value.

Wherein, the inspection apparatus further comprises an output device for generating an alarm signal if the backlight module is abnormal.

The beneficial effects of the present invention are: by comparing the real-time space brightness values measured by the brightness meters with the standard space brightness values corresponding to the standard luminance mode of the backlight module in order to determine if the backlight module is abnormal instantaneously, and using the brightness meter to replace the luminance meter results in the cost saving.

### BRIEF DESCRIPTION OF THE DRAWINGS

FIG. 1 is a schematic drawing of the inspection apparatus of the backlight module of the present invention; and

FIG. 2 is a flow chart of the inspection method of the backlight module of the present invention.

### DETAILED DESCRIPTION OF THE PREFERRED EMBODIMENT

The following combines the drawings and the embodiments for detail description of the present invention.

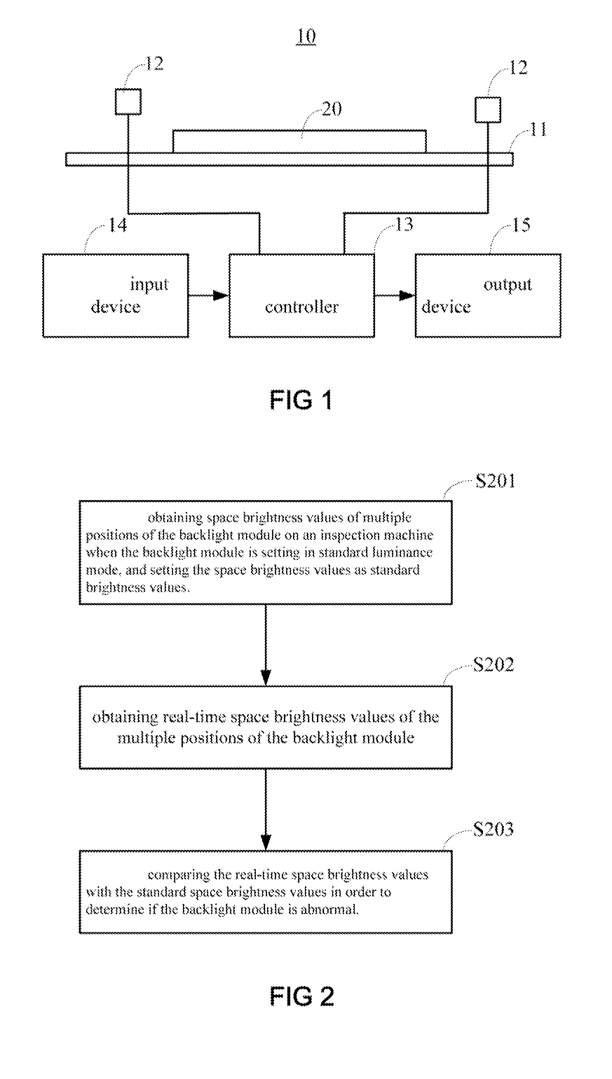

FIG. 1 is a schematic drawing of the inspection apparatus of the backlight module of the present invention. As shown in FIG. 1, the backlight module inspection apparatus 10 comprises: an inspection machine 11, multiple brightness meters 12, a controller 13, an input device 14 and an output device 15.

In this embodiment, it is preferably using four brightness meters 12 to locate at four different positions on the inspection machine 11.

Wherein, the inspection machine 11 is used for carrying the backlight module 20, and the four different positions are preferably at four sides of the backlight module 20. The brightness meters 12 are used for measuring space brightness values of the backlight module in the four positions when it is setting in the standard luminance mode and for measuring real-time space brightness values of the backlight module in the same four positions. The controller 13 are used to set the space brightness values of the backlight module when it is setting in the standard luminance mode as the standard space brightness values and compares the real-time space brightness values with the standard space brightness values for determining if the backlight module 20 is abnormal. Furthermore, the input device 14 is used to set a predetermined threshold value, and the output device 15 is used for generating an alarm signal when the backlight module is abnormal.

In this embodiment, the backlight module 20 which is set in the standard luminance mode, or used for real-time inspection could be the same one or two different backlight modules. In the case of the different two backlight modules, the backlight modules are a standard backlight module and a backlight module waited for inspection. In this situation, it needs to remove the standard backlight module from the inspection machine 11, and places the backlight module waited for inspection in the same position.

The backlight module inspection apparatus 10 works as following processes: inspectors input a predetermined threshold value by the input device 14, and the controller 13 stores the predetermined threshold value. The inspectors place the backlight module 20 on the inspection machine 11, and set the luminance of the backlight module 20 into standard luminance mode. At this time, the four brightness meters 12 measure the space brightness values of the four sides of the backlight module 20 and transmit the space brightness values to the controller 13. The controller 13 obtains the space brightness values and set them as standard space values. The four brightness meters 12 further measure the real-time space brightness values of the four sides of the backlight module 20, and transmit the real-time space brightness values to the controller 13. The controller 13 compares the real-time space brightness values with the standard space brightness values. When the difference between the two is greater than the predetermined threshold value, the controller 13 determines that the backlight module 20 is abnormal and generates an alarm signal by the output device 15. When the difference between the two is less than or equal to the predetermined threshold value, the controller 13 determine that the backlight module 20 is normal.

It is worth noting that the controller 13 can be a built-in industrial computer of the backlight module inspection apparatus 10 or an external server. The input device 14 can be implemented by a processing chip inside the backlight module inspection apparatus 10 with corresponding control code and a keyboard connected to the processing chip or a touch screen (not shown). The output device 15 can be implemented by a processing chip inside the backlight module inspection apparatus 10 with corresponding control code and an alarm device (not shown) connected to the processing chip.

FIG. 2 is a flow chart of the inspection method of the backlight module of present invention. As shown in FIG. 2, the inspection method of the backlight module comprises the following steps:

Step S201: obtaining space brightness values of multiple positions of a backlight module on the inspection machine 11 when the backlight module is setting in standard luminance mode, and setting the space brightness values as standard brightness values.

Wherein, the multiple positions are located preferably at the four sides of the backlight module. The space brightness values are measured by the corresponding brightness meters located at the four sides of the backlight module. The four brightness meters transmit the space brightness values to the controller 13 of the inspection apparatus 10. The controller 13 receives the space brightness values and set them as the standard space brightness values.

Step S202: obtaining real-time space brightness values generated at the multiple positions of the backlight module.

Wherein, the backlight module 20 is setting in the standard luminance mode, or used for real-time inspection could be the same one or two different backlight modules. In the case of the different two backlight modules, the backlight modules are a standard backlight module and a backlight module waited for inspection. In this situation, it needs to remove the standard backlight module from the inspection machine 11, and places the backlight module waited for inspection in the same position.

Step S203: comparing the real-time space brightness values with the standard space brightness values in order to determine if the backlight module is abnormal.

Wherein, the controller 13 of the inspection apparatus 10 obtains and stores a predetermined threshold value by the keyboard or the touch screen connected to it.

The controller 13 of the inspection apparatus 10 receives the real-time space brightness values and compares them with the standard space brightness values. If the difference between the two is greater than a predetermined threshold value, determining the backlight module is abnormal. The inspection apparatus 10 generates an alarm signal by an alarm device (not shown) disposed in it. If the difference between the two is less than or equal to the predetermined threshold value, determining the backlight module is normal.

In summary, the present invention compares the real-time space brightness values measured by the brightness meters with the standard space brightness values corresponding to the standard luminance mode of the backlight module in order to determine if the backlight module is abnormal instantaneously, and using the brightness meters to replace the luminance meters results in cost saving.

The above embodiments of the present invention are not used to limit the claims of this invention. Any use of the content in the specification or in the figures of the present invention which produces the equivalent structures or an equivalent process, or directly or indirectly used in other related technical fields is still covered by the claims in the present invention.

What is claimed is:

1. An inspection method of a backlight module comprising:
obtaining space brightness values of multiple positions of the backlight module on an inspection machine when the backlight module is setting in standard luminance mode, and setting the space brightness values as standard brightness values;
obtaining real-time space brightness values of the multiple positions of the backlight module; and
setting a predetermined threshold brightness value and comparing the real-time space brightness values with the standard space brightness values, wherein if the difference between the two is less than or equal to the predetermined threshold value, determining the backlight module is normal, and if the difference between the two is greater than the predetermined threshold value, determining the backlight module is abnormal and generating an alarm signal.

2. The inspection method as claimed in claim 1, wherein the multiple positions are located at four sides of the backlight module.

3. An inspection method of a backlight module comprising:
obtaining space brightness values of multiple positions of the backlight module on an inspection machine when the backlight module is setting in standard luminance mode, and setting the space brightness values as standard brightness values;
obtaining real-time space brightness values of the multiple positions of the backlight module; and
comparing the real-time space brightness values with the standard space brightness values in order to determine if the backlight module is abnormal.

4. The inspection method as claimed in claim 3, wherein the multiple positions are located at four sides of the backlight module.

5. The inspection method as claimed in claim 3, wherein in the step of comparing the real-time space brightness values with the standard space brightness values in order to determine if the backlight module is abnormal comprises:
comparing the real-time space brightness values with the standard space brightness values, wherein if the difference between the two is greater than a predetermined threshold value, determining the backlight module is abnormal, and if the difference between the two is less than or equal to the predetermined threshold value, determining the backlight module is normal.

6. The inspection method as claimed in claim 5, wherein before the step of comparing the real-time space brightness values with the standard space brightness values in order to determine if the backlight module is abnormal comprises:
setting the predetermined threshold brightness value.

7. The inspection method as claimed in claim 5, wherein, the inspection method further comprising:
generating an alarm signal if the backlight module is abnormal.

8. An inspection apparatus of a backlight module comprising:
an inspection machine for carrying the backlight module;
multiple brightness meters located at multiple positions for measuring space brightness values of multiple positions of the backlight module when the backlight module is setting in standard luminance mode and real-time space brightness values of the multiple positions of the backlight module; and
a controller for setting the space brightness values as standard brightness values and comparing the real-time space brightness values with the standard space brightness values in order to determine if the backlight module is abnormal.

9. The inspection apparatus as claimed in claim 8, wherein the multiple positions are located at four sides of the backlight module.

10. The inspection apparatus as claimed in claim 8, wherein the controller compares the real-time space brightness values with the standard space brightness values, and if the difference between the two is greater than a predetermined threshold value, determining the backlight module is abnormal, and if the difference between the two is less than or equal to the predetermined threshold value, determining the backlight module is normal.

11. The inspection apparatus as claimed in claim 10, wherein the inspection apparatus further comprises an input device for inputting the predetermined threshold value.

12. The inspection apparatus as claimed in claim 10, wherein the inspection apparatus further comprises an output device for generating an alarm signal if the backlight module is abnormal.
